(19) United States
(12) Patent Application Publication
(10) Pub. No.: US 2024/0250627 A1
(43) Pub. Date: Jul. 25, 2024

(54) VIBRATION MOTOR CONTROL CIRCUIT, CONTROL METHOD AND DEVICE THEREOF

(71) Applicant: Beijing Zitiao Network Technology Co., Ltd., Beijing (CN)

(72) Inventors: Jingheng WANG, Beijing (CN); Xuebing DENG, Beijing (CN); Xiaowei MA, Beijing (CN); Xuebin GAO, Beijing (CN); Zhaomeng LIU, Beijing (CN)

(21) Appl. No.: 18/540,815

(22) Filed: Dec. 14, 2023

(30) Foreign Application Priority Data
Jan. 19, 2023 (CN) 202310096414.8

(51) Int. Cl. H02P 25/034

(52) U.S. Cl. CPC H02P 25/034; G08B 6/00

(57) ABSTRACT

The application provides a vibration motor control circuit and a control method and a device thereof, the control circuit includes: a controller, a driver, a switch component, and a vibration motor; a first terminal of the switch component is connected with one terminal of the vibration motor, a second terminal of the switch component is connected with another terminal of the motor and a first output terminal of the driver, a third terminal of the switch component is connected with a second output terminal of the driver; a first output terminal of the controller is connected with an input terminal of the driver, a second output terminal of the controller is connected with the first terminal of the switch component, to transmit a control instruction to the first terminal of the switch component after the motor stops vibrating.

### CROSS REFERENCE TO RELATED APPLICATIONS

This disclosure claims the priority of the Chinese Patent Application filed to the China Patent Office on Jan. 19, 2023, with the application number 202310096414.8 and the invention name of “VIBRATION MOTOR CONTROL CIRCUIT, CONTROL METHOD AND DEVICE THEREOF”, the entire disclosures of which are incorporated by reference as part of the disclosure of this application.

### TECHNICAL FIELD

The application relates to the field of circuit control, and in particular, to a vibration motor control circuit and a control method and a device thereof.

### BACKGROUND

By applying tactile feedback technology in electronic devices such as handles and smartphones, tactile feedback technology can be used to reproduce the tactile sensation for a user through a sequence of actions such as force and vibration, wherein the core component to implement tactile feedback technology is the vibration motor.

In practical use, after controlling the vibration of the vibration motor to output vibration feedback to the user (that is, after the vibration motor stops vibrating), the aftershocks generated by the vibration motor will make the electronic device integrated with the inertial sensor produce false alarms and lead to abnormal noise or abnormal jitter of the vibration motor, which will affect the user experience seriously. Therefore, how to eliminate the aftershocks generated after the vibration motor stops vibrating has become an urgent problem that needs to be solved.

### SUMMARY

The application provides a vibration motor control circuit, a control method, and a device thereof, which may eliminate aftershocks generated by the vibration motor quickly, and is not only simple in structure and easy to implement, but also can reduce or even avoid the phenomena such as false alarm of inertial sensors, abnormal noise or abnormal jitter of the motor caused by aftershocks of the vibration motor, thereby improving the user experience effectively.

In the first aspect, the application provides a vibration motor control circuit, comprising: a controller, a driver, a switch component, and a vibration motor:
a first terminal of the switch component is connected with one terminal of the vibration motor, a second terminal of the switch component is connected with another terminal of the vibration motor and a first output terminal of the driver, and a third terminal of the switch component is connected with a second output terminal of the driver: and
a first output terminal of the controller is connected with an input terminal of the driver, and a second output terminal of the controller is connected with the first terminal of the switch component, the second output terminal of the controller is used for transmitting a control instruction to the first terminal of the switch component after the vibration motor stops vibrating, and controlling the first terminal of the switch component to be disconnected from the third terminal of the switch component, and controlling the first terminal of the switch component to be connected with the second terminal of the switch component.

In the second aspect, the application provides a control method of a vibration motor control circuit, comprising:
determining whether a vibration duration of a vibration motor reaches a preset duration; and
in response to the vibration duration reaching the preset duration, disconnecting a connection between the vibration motor and a driver to allow the vibration motor to be shorted out.

In the third aspect, the application provides an electronic device, comprising the vibration motor control circuit of any one of the embodiments of the first aspect.

In the fourth aspect, the application provides a handheld control apparatus, comprising the vibration motor control circuit of any one of the embodiments of the first aspect and an inertial sensor.

The technical solution disclosed in the embodiments of the application has the following technical effects:

A switch component is disposed in a vibration motor control circuit, a first terminal of the switch component is connected with one terminal of a vibration motor, a second terminal of the switch component is connected with another terminal of the vibration motor and a first output terminal of a driver, a third terminal of the switch component is connected with a second output terminal of the driver, and a first output terminal of a controller in the vibration motor control circuit is connected with an input terminal of the driver, a second output terminal of the controller is connected with the first terminal of the switch component, which is used to transmit a control instruction to the first terminal of the switch component after the vibration motor stops vibrating, to control the first terminal of the switch component to be disconnected from the third terminal of the switch component, and to control the first terminal of the switch component to be connected with the second terminal of the switch component. Therefore, after the vibration motor is controlled to stop vibrating, the connection between the vibration motor and the driver is disconnected by controlling the switch component, causing the vibration motor to be shorted out, so that the kinetic energy of vibration of the vibration motor is converted into the thermal energy of the vibration motor coil, so that the aftershocks generated by the vibration motor may be quickly eliminated, and the structure is simple and easy to implement, and the phenomena such as false alarm of the inertial sensor, abnormal noise or abnormal vibration of the motor and the like caused by the aftershocks of the vibration motor can be reduced or even avoided so that the user experience may be improved effectively.

### BRIEF DESCRIPTION OF DRAWINGS

In order to explain the technical solution in the embodiments of the application more clearly, the drawings needed in the description of the embodiments will be introduced briefly below. It is obvious that the drawings in the following description are only some embodiments of the application. For those ordinary skilled in the art, other drawings can be obtained according to these drawings without inventive work.

FIG. 1 is a schematic block diagram of one vibration motor control circuit provided by embodiments of the present application:

FIG. 2 is a schematic block diagram of another vibration motor control circuit provided by embodiments of the present application:

FIG. 3 is a flowchart of a control method of the vibration motor control circuit provided by embodiments of the present application:

FIG. 4 is a schematic block diagram of an electronic device provided by embodiments of the present application:

FIG. 5 is a schematic block diagram of a handheld control apparatus provided by embodiments of the present application.

### DETAILED DESCRIPTION

In the following, the technical solution in the embodiments of the application will be clearly and completely described concerning the drawings in the embodiments of the application. It is obvious that the described embodiment is only a part of the embodiments of the application, but not the whole embodiments. Based on the embodiments in the application, all other embodiments obtained by those ordinary skilled in the art without inventive work belong to the protection scope of the application.

It should be noted that the terms “first” and “second” in the description and claims and the above drawings of the application are used to distinguish similar objects and are not necessarily used to describe a specific order or sequence. It should be understood that the data so used are interchangeable under appropriate cases so that the embodiments of the application described herein can be implemented in sequences other than those illustrated or described herein. Furthermore, the terms “including” and “comprising” and any variations thereof are intended to cover non-exclusive inclusion, for example, a process, method, system, product, or server that includes a sequence of steps or units are not necessarily limited to those steps or units are explicitly listed, but may include other steps or units that are not explicitly listed or that are inherent to the process, method, product or device.

The application applies to output vibration feedback to the user by controlling the vibration of the vibration motor in an electronic device. Aftershocks will be generated after the vibration motor stops vibrating, and the aftershocks will cause false alarms in an electronic device integrated with inertial sensors, which will affect the user experience seriously. Therefore, to solve the problem, the application designs a vibration motor control circuit, which can eliminate the aftershocks after the vibration motor stops vibrating, thereby improving the user experience effectively.

A vibration motor control circuit provided by embodiments of the present application will be described in detail with reference to the accompanying drawings.

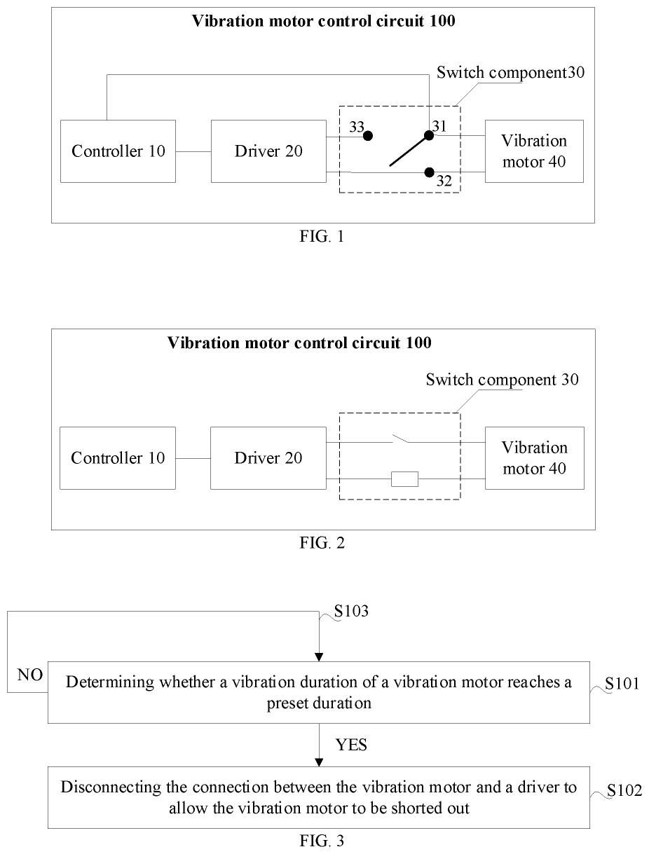

FIG. 1 is a schematic block diagram of one vibration motor control circuit provided by an embodiment of the present application.

As shown in FIG. 1, a vibration motor control circuit 100 provided by embodiments of the present application includes a controller 10, a driver 20, a switch component 30, and a vibration motor 40:
wherein a first terminal 31 of the switch component 30 is connected with one terminal of the vibration motor 40, and a second terminal 32 of the switch component 30 is connected with another terminal of the vibration motor 41 and a first output terminal of the driver 20, and a third terminal 33 of the switch component 30 is connected with a second output terminal of the driver 20.
a first output terminal of the controller 10 is connected with an input terminal of the driver 20, and a second output terminal of the controller 10 is connected with the first terminal 31 of the switch component 30, which is used to transmit a control instruction to the first terminal 31 of the switch component 30 after the vibration motor 40 stops vibrating, to control the first terminal 31 of the switch component 30 to be disconnected from the third terminal 33 of the switch component 30, and to control the first terminal 31 of the switch component 30 to be connected with the second terminal 32 of the switch component 30.

It should be noted that the first terminal 31 of the switch component 30 in the application is a control terminal of the switch component, which is used to control the operating state of the switch component 30 itself according to the control instruction transmitted by the controller 10, such as switching the on state between the first terminal 31 and the third terminal 33 to the off state and switching the off state between the first terminal 31 and the second terminal 32 to the on state.

In the embodiment, the driver 20 specifically refers to a vibration motor driver for driving the vibration motor 40 to vibrate.

In the embodiment, the vibration motor 40 is a linear vibration motor or a broadband vibration motor. Other types of vibration motors may be used in addition to the above two types of vibration motors obviously, and there is no specific limitation herein.

Specifically, when the electronic device needs to output vibration feedback to the user, it may transmit a vibration signal to the driver 20 in the vibration motor control circuit 100 through the controller 10, so that the driver 20 may invoke a preset vibration waveform according to the vibration signal, and control the vibration motor 40 to vibrate based on the preset vibration waveform, so as to output vibration feedback to the user.

When the vibration motor 40 is controlled to vibrate, the corresponding pins of two terminals of the vibration motor 40 (such as one terminal and another terminal of the vibration motor 40 in FIG. 1) are connected with the driver 20 respectively. That is, one terminal of the vibration motor 40 is connected to the third terminal 33 connected to the second output terminal of the driver 20 through the first terminal 31 of the switch component 30, and another terminal of the vibration motor 40 is connected to the first output terminal of the driver 20 through the second terminal 32 of the switch component 30, thereby the two pins of the vibration motor 40 are connected directly to the driver 20. Further, the vibration motor 40 outputs vibration feedback to the user according to the preset vibration waveform output by the driver 20. That is, at the time, the corresponding pins of the two terminals of the vibration motor 40 are not shorted out and are both in a high resistance state.

It should be illustrated that in the embodiment, the preset vibration waveform is set adaptively according to the type of vibration motor, and the preset vibration waveform is pre-configured in the driver 20 of the vibration motor control circuit 100. Therefore, the driver 20 may directly invoke the preset vibration waveform from the configuration information according to the vibration signal transmitted by the controller 10, thereby improving the response speed of controlling the vibration of the vibration motor 40.

After the vibration motor 40 is controlled to vibrate according to the preset vibration waveform, the controller 10 can transmit a control instruction (vibration stopping signal) to the switch component 30 (i.e., the first terminal 31 of the switch component 30), so that the switch component 30 can disconnect the first terminal 31 from the third terminal 33 and connect the first terminal 31 with the second terminal 32 within a microsecond time based on the above vibration stopping signal. That is, according to the vibration stopping signal transmitted by the controller 10, the switch component 30 switches its first terminal 31 from the state of being connected with the second output terminal of the driver 20 to the state of being connected with another terminal of the vibration motor 40, causing the corresponding pins of the two terminals of the vibration motor 40 to be shorted out, and thereby achieving the purpose of allowing the vibration motor 40 to be shorted out, so that aftershocks generated after the vibration motor 40 stops vibrating will generate an induced magnetic field in the closed vibration motor coil. Through the induced magnetic field, the movement of the vibrator of the vibration motor 40 can be quickly suppressed, causing the vibration motor 40 to stop vibrating quickly.

That is, in the application, the vibration kinetic energy of the vibration motor 40 is converted into the thermal energy of the coil of the vibration motor 40, so as to quickly eliminate the aftershocks generated after the vibration motor 40 stops vibrating, thereby reducing or even avoiding the phenomena such as false alarm of the inertial sensor, abnormal noise or abnormal jitter caused by the aftershocks generated by the vibration motor 40.

Further, in order to output different vibration feedback to the user, as an optional implementation, the embodiments of the present application can configure the driver 20 with a plurality of preset vibration waveforms with different vibration parameters. Among them, the vibration parameters can be but not limited to vibration intensity, vibration duration, vibration frequency, and repetition times.

After configuring the driver 20 with a plurality of preset vibration waveforms with different vibration parameters, the controller 10 in the embodiments may transmit a vibration signal with vibration parameters to the driver 20 in the vibration motor control circuit 100 when the vibration motor 40 needs to output vibration feedback to the user. After the driver 20 receives the vibration signal transmitted by the controller 10, it analyzes the received vibration signal to obtain the vibration parameters carried by the vibration signal. Then, the driver 20 obtains the target vibration waveform from a plurality of preset vibration waveforms configured in advance according to the obtained vibration parameters and invokes the target vibration waveform to control the vibration of the vibration motor 40. Therefore, the vibration motor can be controlled to output different vibration feedbacks to the user according to the vibration signal with vibration parameters transmitted by the controller 10, which may enrich the user's tactile experience and satisfy the user's use requirements significantly.

It should be noted that in the embodiment, the switch component 30 may be a controllable switch circuit of the switch, as shown in FIG. 1. The switch circuit in the application may be a single-pole double-throw (SPDT) switch.

Further, as shown in FIG. 2, the switch component 30 in the embodiments of the present application can also be a normally closed relay.

Specifically, when the switch component 30 is a normally closed relay, one terminal of the switch element in the normally closed relay in the application is connected to one terminal of the vibration motor 40: another terminal of the switch element in the normally closed relay is connected with the second output terminal of the driver 20: one terminal of the coil in the normally closed relay is connected with another terminal of the vibration motor 40; another terminal of the coil in the normally closed relay is connected to the first output terminal of the driver 20.

That is, when the controller 10 needs to control the vibration of the vibration motor 40 to output vibration feedback to the user, the driver 20 can invoke the preset vibration waveform to control the vibration of the vibration motor 40 by controlling the switch element in the switch component 30 in the vibration motor control circuit 100 to close. After controlling the vibration motor 40 to vibrate according to the preset vibration waveform, the controller 10 may transmit a vibration stopping signal to the switch component 30 to control the switch element in the switch component 30 to be disconnected, causing the corresponding pins of the two terminals of the vibration motor 40 to be shorted out, and the vibration motor 40 is shorted out. That is, the connection between the vibration motor 40 and the driver 20 is disconnected, so as to convert the kinetic energy of the vibration of the vibration motor into the thermal energy of the vibration motor coil, that is, the aftershocks generated by the vibration motor can be quickly eliminated by relying on the energy consumption of the vibration motor 40 itself.

It should be understood that the connection mode of the above normally closed relay can also be that one terminal of the switch element in a relay of normally closed type is connected to another terminal of the vibration motor 40; another terminal of the switch element in the relay of normally closed type is connected with the first output terminal of the driver 20; one terminal of the coil in the relay of normally closed type is connected with one terminal of the vibration motor 40; another terminal of the coil in the relay of normally closed type is connected to the second output terminal of the driver 20. That is, the application does not specifically limit the manner in which the relay of normally closed type is connected to the vibration motor control circuit 100.

According to the vibration motor control circuit provided by the application, a switch component is disposed in the vibration motor control circuit, the first terminal of the switch component is connected with one terminal of the vibration motor, the second terminal of the switch component is connected with another terminal of the vibration motor and the first output terminal of the driver, and the third terminal of the switch component is connected with the second output terminal of the driver, and the first output terminal of the controller in the vibration motor control circuit is connected with the input terminal of the driver, the second output terminal of the controller is connected with the first terminal of the switch component, which is used to transmit a control instruction to the first terminal of the switch component after the vibration motor stops vibrating, so as to control the first terminal of the switch component to be disconnected from the third terminal of the switch component and control the first terminal of the switch component to be connected with the second terminal of the switch component. Therefore, after the vibration motor is controlled to stop vibrating, the connection between the vibration motor and the driver is disconnected by controlling the switch component, causing the vibration motor to be shorted out, so that the kinetic energy of vibration of the vibration motor is converted into the thermal energy of the vibration motor coil, so that the aftershocks generated by the vibration motor can be eliminated quickly, and the structure is simple and easy to implement, and the phenomena such as false alarm of the inertial sensor, abnormal noise or abnormal vibration of the motor caused by the aftershocks of the vibration motor can be reduced or even avoided, so that the user experience may be improved effectively.

Based on the vibration motor control circuit provided in the above embodiments, the application also provides a control method for the vibration motor control circuit. It should be illustrated that the control method for the vibration motor control circuit provided by the embodiments can be applied to the vibration motor control circuit of the above embodiments.

In combination with FIG. 3, the control method of the vibration motor control circuit provided by the embodiments of the present application will be described in detail.

FIG. 3 is a flowchart of a control method of the vibration motor control circuit provided by embodiments of the present application. Specifically, as shown in FIG. 3, the control method of the vibration motor control circuit comprises the following steps:
S101, determining whether a vibration duration of the vibration motor reaches a preset duration, in response to the vibration duration reaching the preset duration, S102 is executed, otherwise S103 is executed.

The preset duration refers to the duration of vibration of the vibration motor. The preset duration is determined specifically based on the situation in which the controller controls the vibration motor to output vibration feedback to the user. For example, the preset duration may be 5 seconds (s), etc.

In the embodiment, the vibration motor is a linear vibration motor or a broadband vibration motor. Other types of vibration motors may be used in addition to the above two types of vibration motors, and there is no specific limitation to them herein.

Specifically, when it is detected that the user is shooting or punching someone or the like that needs to control the vibration of the vibration motor to output vibration feedback to the user, the controller may transmit a vibration signal to the driver. When the driver receives the vibration signal transmitted by the controller, it may invoke the preset vibration waveform configured in advance according to the vibration signal and control the vibration of the vibration motor based on the preset vibration waveform.

Moreover, the vibration signal transmitted by the controller may carry vibration parameters, so that after the driver receives the vibration signal transmitted by the controller, the vibration parameters carried by the vibration signal may be obtained by parsing the received vibration signal. Then, according to the obtained vibration parameters, the driver obtains the target vibration waveform from a plurality of preset vibration waveforms configured in advance and invokes the target vibration waveform to control the vibration of the vibration motor. Therefore, the vibration motor may be controlled to output different vibration feedbacks to the user according to the vibration signal with vibration parameters transmitted by the controller, which can enrich the user's tactile experience and satisfy the usage requirement of the user significantly.

In the embodiment, the vibration parameters may be, but not limited to, vibration intensity, vibration duration, vibration frequency, repetition times, etc.

That is, a plurality of preset vibration waveforms with different vibration parameters are pre-configured for the driver, so that the driver may invoke the target vibration waveform corresponding to the vibration parameters according to the vibration parameters carried by the vibration signal transmitted by the controller, and the vibration motor may output corresponding vibration feedback to the user according to the target vibration waveform.

Further, based on the invoked vibration waveform, during the process of controlling the vibration of the vibration motor, the controller may also monitor whether a vibration duration of the vibration motor reaches a preset duration in real time.

Specifically, monitoring whether the vibration duration of the vibration motor reaches a preset duration is particularly to monitor whether the preset vibration waveform invoked by the driver has been played completely. When the preset vibration waveform has been played completely, it means that the vibration duration of the vibration motor has reached the preset duration: when the preset vibration waveform has not been played completely, it means that the vibration duration of the vibration motor has not reached the preset duration.

When it is determined that the monitored vibration duration of the vibration motor reaches the preset duration, it means that the vibration driving of the vibration motor has ended, and at this time, the operation of controlling the vibration of the vibration motor to output vibration feedback to the user may be ended. When it is determined that the vibration duration of the vibration motor does not reach the preset duration, it means that the vibration driving of the vibration motor is not finished, and the vibration duration of the vibration motor is continuously monitored until the vibration duration of the vibration motor reaches the preset duration.

S102, in response to the vibration duration reaching the preset duration, disconnecting the connection between the vibration motor and a driver to allow the vibration motor to be shorted out.

Considering that after the vibration motor stops vibrating, the vibration motor will not stop vibrating immediately, but will stop vibrating gradually by reducing the vibration intensity. Aftershocks will be generated when the vibration motor stops vibrating gradually, which will cause a false alarm of the electronic device integrated with inertial sensors and lead to abnormal noise or abnormal jitter of the vibration motor. Therefore, in the application, to eliminate the aftershocks after the vibration motor stops vibrating after the vibration motor is controlled to stop vibrating, the controller transmits a vibration stopping signal to disconnect the connection between the vibration motor and the driver, causing the vibration motor to be shorted out. So that the vibration motor coil is in a closed state after the vibration motor is shorted out, and an induced magnetic field is generated in the vibration motor coil based on aftershocks generated after the vibration motor stops vibrating so that the vibration of the vibration motor can be suppressed quickly.

That is, in the application, the vibration kinetic energy of the vibration motor is converted into the thermal energy of the vibration motor coil to quickly eliminate the aftershocks generated after the vibration motor stops vibrating, thereby reducing or even avoiding the phenomena such as false alarm of the inertial sensor, abnormal noise or abnormal vibration of the motor and the like caused by the aftershocks generated by the vibration motor 40.

In the embodiment, the connection between the vibration motor and the driver is disconnected, specifically, the switch component between the vibration motor and the driver is controlled to be disconnected.

The switch component comprises a first terminal, a second terminal and a third terminal, wherein the first terminal of the switch component is connected with one terminal of the vibration motor, and the second terminal of the switch component is connected with another terminal of the vibration motor and the first output terminal of the driver, and the third terminal of the switch component is connected with the second output terminal of the driver:

Accordingly, controlling the switch component between the vibration motor and the driver to be disconnected specifically includes:
controlling the first terminal of the switch component to be disconnected from the third terminal of the switch component and controlling the first terminal of the switch component to be connected with the second terminal of the switch component. The specific process of implementation may refer to the vibration motor control circuit part described above, and it will not be described in detail here.

That is, the application controls the switch component to switch its first terminal from the state of being connected with the second output terminal of the driver to the state of being connected with another terminal of the vibration motor according to the vibration stopping signal transmitted by the controller, so that the corresponding pins of the two terminals of the vibration motor are shorted out, and the purpose of allowing the vibration motor to be shorted out is achieved, so that aftershocks generated after the vibration motor stops vibrating will generate an induced magnetic field in the coil of the vibration motor, and the movement of the vibrator of the vibration motor can be suppressed quickly by the induced magnetic field, so that the vibration motor can stop vibrating quickly.

It should be noted that in the embodiment, the switch component is a controllable switch circuit or a normally closed relay, wherein the switch circuit of a switch may be a single-pole double-throw (SPDT) switch.

S103, in response to the vibration duration not reaching the preset duration, returning to S101.

The control method of the vibration motor control circuit provided by the application determines whether a vibration duration of a vibration motor reaches a preset duration, and when the vibration duration reaches the preset duration, the connection between the vibration motor and a driver is disconnected, causing the vibration motor to be shorted out. Therefore, after the vibration motor is controlled to stop vibrating, the connection between the vibration motor and the driver is disconnected by controlling the switch component, causing the vibration motor to be shorted out, so that the kinetic energy of vibration of the vibration motor is converted into the thermal energy of the vibration motor coil, so that the aftershocks generated by the vibration motor can be eliminated quickly, and the structure is simple and easy to implement, and the phenomena such as false alarm of the inertial sensor, abnormal noise or abnormal jitter of the motor caused by the aftershocks of the vibration motor can be reduced or even avoided, so that the user experience may be improved effectively.

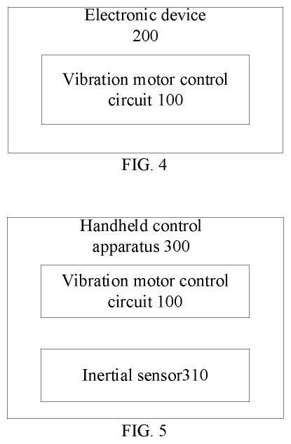

FIG. 4 is a schematic block diagram of an electronic device provided by embodiments of the present application.

As shown in FIG. 4, the electronic device 200 includes the vibration motor control circuit 100 described in any of the above embodiments.

In the embodiment, the electronic device 200 can be any hardware device supporting vibration feedback technology, such as a VR handle or a smartphone. In addition, an inertial sensor (not shown) is integrated into the electronic device 200.

According to the electronic device provided by the embodiments of the application, a switch component is disposed in the vibration motor control circuit, the first terminal of the switch component is connected with one terminal of the vibration motor, and the second terminal of the switch component is connected with another terminal of the vibration motor and the first output terminal of the driver, and the third terminal of the switch component is connected with the second output terminal of the driver, and the first output terminal of the controller in the vibration motor control circuit is connected with the input terminal of the driver, and the second output terminal of the controller is connected with the first terminal of the switch component, which is used to transmit a control instruction to the first terminal of the switch component after the vibration motor stops vibrating, to control the first terminal of the switch component to be disconnected from the third terminal of the switch component and to control the first terminal of the switch component to be connected with the second terminal of the switch component. Therefore, after the vibration motor is controlled to stop vibrating, the connection between the vibration motor and the driver is disconnected by controlling the switch component, causing the vibration motor to be shorted out, so that the kinetic energy of vibration of the vibration motor is converted into the thermal energy of the vibration motor coil, so that the aftershocks generated by the vibration motor can be eliminated quickly, and the structure is simple and easy to implement, and the phenomena such as false alarm of the inertial sensor, abnormal noise or abnormal vibration of the motor caused by the aftershocks of the vibration motor can be reduced or even avoided so that the user experience may be improved effectively.

FIG. 5 is a schematic block diagram of a handheld control apparatus provided by embodiments of the present application.

As shown in FIG. 5, the handheld control apparatus 300 includes the vibration motor control circuit 100 and the inertial sensor 310 described in any of the above embodiments.

Optionally, the handheld control apparatus 300 in the application includes, but is not limited to, a handle, a hand controller, gloves, a bracelet, and a ring.

In the handheld control apparatus provided by the embodiments of the application, a switch component is disposed in the vibration motor control circuit, the first terminal of the switch component is connected with one terminal of the vibration motor, and the second terminal of the switch component is connected with another terminal of the vibration motor and the first output terminal of the driver, and the third terminal of the switch component is connected with the second output terminal of the driver, and the first output terminal of the controller in the vibration motor control circuit is connected with the input terminal of the driver, the second output terminal of the controller is connected with the first terminal of the switch component, which is used to transmit a control instruction to the first terminal of the switch component after the vibration motor stops vibrating, to control the first terminal of the switch component to be disconnected from the third terminal of the switch component and to control the first terminal of the switch component to be connected with the second terminal of the switch component. Therefore, after the vibration motor is controlled to stop vibrating, the connection between the vibration motor and the driver is disconnected by controlling the switch component, causing the vibration motor to be shorted out, so that the kinetic energy of vibration of the vibration motor is converted into the thermal energy of the vibration motor coil, so that the aftershocks generated by the vibration motor can be eliminated quickly, and the structure is simple and easy to implement, and the phenomena such as false alarm of the inertial sensor, abnormal noise or abnormal vibration of the motor caused by the aftershocks of the vibration motor can be reduced or even avoided, so that the user experience may be improved effectively.

Those ordinary skilled in the art can realize that the modules and algorithm steps described in connection with the embodiments disclosed herein can be implemented in electronic hardware, computer software, or a combination thereof. Whether these functions are implemented in hardware or software depends on the specific application and design constraints of the technical solution. Those skilled in the art can use different methods to implement the described functions for each specific application, but the implementation should not be considered beyond the scope of the application.

In several embodiments provided by the application, it should be understood that the disclosed systems, apparatus, and methods can be implemented in other ways. For example, the apparatus embodiment described above is only schematic. For example, the partition of the module is only a logical function partition. In practice, there may be other partition methods, for example, multiple modules or components may be combined or integrated into another system, or some features can be ignored or not implemented. On the other hand, the mutual coupling, or direct coupling, or communication connection illustrated or discussed may be by some interfaces, the indirect coupling or communication connection of the apparatus or modules may be electrical, mechanical, or in other forms.

The modules described as separate components may or may not be physically separated, and the components illustrated as modules may or may not be physical modules, that is, they may be located in one place or distributed to multiple network units. Some or all of the modules can be selected according to actual needs to achieve the purpose of the embodiment. For example, each functional module in each embodiment of the application can be integrated into one processing module, or each module can be physically alone, or two or more modules can be integrated into one module.

The above are only the specific implementations of the application, but the protection scope of the application is not limited thereto. Any person familiar with the technical field can easily think of changes or substitutions within the technical scope disclosed in the application, which should be covered by the application. Therefore, the protection scope of the application should be based on that of what is claimed.

What is claimed is:

1. A vibration motor control circuit, comprising: a controller, a driver, a switch component, and a vibration motor,
wherein a first terminal of the switch component is connected with one terminal of the vibration motor, a second terminal of the switch component is connected with another terminal of the vibration motor and a first output terminal of the driver, and a third terminal of the switch component is connected with a second output terminal of the driver; and
a first output terminal of the controller is connected with an input terminal of the driver, and a second output terminal of the controller is connected with the first terminal of the switch component, the second output terminal of the controller is configured to transmit a control instruction to the first terminal of the switch component after the vibration motor stops vibrating, to control the first terminal of the switch component to be disconnected from the third terminal of the switch component, and to control the first terminal of the switch component to be connected with the second terminal of the switch component.

2. The vibration motor control circuit of claim 1, wherein the switch component is a controllable switch circuit.

3. The vibration motor control circuit of claim 1, wherein the switch component is a normally closed relay.

4. The vibration motor control circuit of claim 3,
wherein one terminal of a switch element in the normally closed relay is connected with one terminal of the vibration motor;
another terminal of the switch element in the normally closed relay is connected with the second output terminal of the driver;
one terminal of a coil in the normally closed relay is connected with another terminal of the vibration motor; and
another terminal of the coil in the normally closed relay is connected with the first output terminal of the driver.

5. The vibration motor control circuit of claim 1, wherein the vibration motor is a broadband vibration motor or a linear vibration motor.

6. A control method of a vibration motor control circuit, comprising:
determining whether a vibration duration of a vibration motor reaches a preset duration; and
in response to the vibration duration reaching the preset duration, disconnecting a connection between the vibration motor and a driver to allow the vibration motor to be shorted out.

7. The method of claim 6, wherein disconnecting the connection between the vibration motor and the driver comprises:
controlling a switch component between the vibration motor and the driver to be disconnected.

8. The method of claim 7, wherein the switch component comprises a first terminal, a second terminal, and a third terminal, the first terminal of the switch component is connected with one terminal of the vibration motor, the second terminal of the switch component is connected with another terminal of the vibration motor and a first output terminal of the driver, and the third terminal of the switch component is connected with a second output terminal of the driver; and
controlling the switch component between the vibration motor and the driver to be disconnected comprises:
controlling the first terminal of the switch component to be disconnected from the third terminal of the switch component and controlling the first terminal of the switch component to be connected with the second terminal of the switch component.

9. The method of claim 7, wherein the switch component is a controllable switch circuit.

10. An electronic device, comprising the vibration motor control circuit of claim 1.

11. A handheld control apparatus, comprising the vibration motor control circuit of claim 1 and an inertial sensor.

12. The vibration motor control circuit of claim 2, wherein the vibration motor is a broadband vibration motor or a linear vibration motor.

13. The vibration motor control circuit of claim 3, wherein the vibration motor is a broadband vibration motor or a linear vibration motor.

14. The vibration motor control circuit of claim 4, wherein the vibration motor is a broadband vibration motor or a linear vibration motor.

15. The method of claim 7, wherein the switch component is a normally closed relay.

16. The method of claim 15, wherein,
wherein one terminal of a switch element in the normally closed relay is connected with one terminal of the vibration motor;
another terminal of the switch element in the normally closed relay is connected with the second output terminal of the driver;
one terminal of a coil in the normally closed relay is connected with another terminal of the vibration motor; and
another terminal of the coil in the normally closed relay is connected with the first output terminal of the driver.

17. The method of claim 6, wherein the vibration motor is a broadband vibration motor.

18. The method of claim 6, wherein the vibration motor is a linear vibration motor.

19. The method of claim 6, wherein the vibration motor control circuit comprises a controller, the driver, a switch component, and the vibration motor.

20. The method of claim 19, wherein a first output terminal of the controller is connected with an input terminal of the driver, and a second output terminal of the controller is connected with the first terminal of the switch component, the second output terminal of the controller is configured to transmit a control instruction to the first terminal of the switch component after the vibration motor stops vibrating, to control the first terminal of the switch component to be disconnected from the third terminal of the switch component, and to control the first terminal of the switch component to be connected with the second terminal of the switch component.
